(19) United States
(12) Patent Application Publication
(10) Pub. No.: US 2011/0240177 A1
(43) Pub. Date: Oct. 6, 2011

(54) DEVICE AND METHOD FOR HARDENING METALLIC WORK PIECES

(75) Inventor: Wolfgang Eberlein, Wiesbaden (DE)

(73) Assignee: GM GLOBAL TECHNOLOGY OPERATIONS LLC, Detroit, MI (US)

(21) Appl. No.: 13/133,901

(22) PCT Filed: Dec. 9, 2009
(86) PCT No.: PCT/EP2009/008781

§ 371 Date: Jun. 9, 2011

(30) Foreign Application Priority Data
Dec. 15, 2008 (DE) 102008062270.2

(51) Int. Cl. C21D 11/00; C22F 1/00; C21D 9/00; H05B 6/10

(52) U.S. Cl. 148/508; 148/714; 148/400; 266/249; 266/99; 219/602

(57) ABSTRACT

A device and to a corresponding method for partially hardening a metallic work piece, in which the work piece is transported in a continuous furnace along a conveying direction by means of a conveyor and partially heated by means of a heating device. It is proposed that the heating device generates at least one heating zone that is moved in the conveying direction together with the work piece.

### CROSS-REFERENCE TO RELATED APPLICATIONS

This application is a U.S. National-Stage entry under 35 U.S.C. §371 based on International Application No. PCT/EP2009/008781, filed Dec. 9, 2009 which was published under PCT Article 21(2) and which claims priority to German Application No. 102008062270.2, filed Dec. 15, 2008, which are all hereby incorporated in their entirety by reference.

### TECHNICAL FIELD

The present invention pertains to a device and a method for partially hardening a metallic work piece, particularly steel parts that are cut in the form of tailored blanks, especially for use in the automotive industry. The invention also pertains to correspondingly manufactured or processed metallic work pieces.

### BACKGROUND

In the automotive industry, it is becoming more and more popular to use car body parts that are especially manufactured in accordance with the specified load requirements. Depending on the intended use of such car body parts or supporting structure components, they need to fulfill the respectively specified load requirements. For example, the B-column of a car body is realized such that it has a relatively high structural rigidity in the thorax region, i.e., in a central section referred to the vertical direction, and a lower rigidity and therefore an increased deformability in the upper and lower regions that are connected to the car body.

Such a profile of requirements can be realized, for example, by means of so-called Tailor Welded Blanks or Tailor Welded Coils. In this case, materials such as, e.g., steel blanks or steel strips of different quality, hardness and/or different geometry are joined before the desired contour of a thusly joined initial work piece is produced, e.g., by means of a cold forming or hot forming process.

The utilization of such Tailored Blanks or Tailored Coils is relatively cost-intensive because the initial work piece needs to be subjected to a joining process prior to the actual forming process. In addition, severe problems arise in a subsequent hot forming process. The effect of the heat may cause changes in the welding seam that can ultimately lead to softening of the welding seams in the finished component and compromise the quality and functionality thereof

For example, DE 36 18 093 A1 discloses an automatic device for induction hardening parts of chain links, wherein this device comprises a frame for supporting induction devices. The frame is able to swing back and forth in a horizontal plane above the chain links to be hardened such that the induction device is able to inductively harden chain links of different sizes and shapes by varying the stroke of the frame.

Furthermore, a continuous production line for manufacturing partially hardened products, particularly hardened thin sheet metal profiles produced of a coiled metal strip, is known, for example, from DE 692 27 763 T2. This production line comprises an uncoiler for uncoiling the strip, a roller unit for providing the strip with a profile and a heating unit.

The heating unit comprises a discontinuously operated electric heating coil, the shape of which is adapted to the cross-sectional area of the profile produced by the roller in such a way that only certain regions along the length of the profile can be heated. In addition, a quenching unit for cooling the profile and for hardening heated regions and a fly cutter unit for cutting the profile on at least a few of its non-hardened regions are provided in order to obtain individual products with the desired length.

Consequently, the product to be manufactured is only partially hardened, i.e., in regions or locations that are spaced apart from one another, while other regions situated in between remain in the non-hardened state. This makes it possible to manufacture a product with regions that have different structural rigidities.

The described heating unit or its electric heating coil is realized stationarily such that the parameters heating power, advance speed of the work piece and size of the heating coil or the induction field generated therewith are fixedly interrelated when heating the work piece to a predetermined temperature.

The partially hardened products that can be produced by means of a continuously operating hardening device typically feature relatively large transition areas between surface sections with different degrees of hardness. The actual work piece hardness in such transition areas cannot be predicted very accurately. It may furthermore fluctuate quite significantly in dependence on the process. The disadvantageous effects of these inadequacies become particularly evident in a comparison between the simulated and the actual crash behavior of a vehicle. The reason for this can be seen in that the actual degree of hardness in each transition area cannot be very accurately mapped in a simulation model.

At least one objective is to make available an improved device and an improved method for hardening metallic work pieces that allow a universal handling with respect to the partial heating of the work piece. It is also an aim to lower the manufacturing costs and to reduce the cycle times. It should furthermore be possible to produce hardened and non-hardened regions that are very clearly and distinctly separated from one another and therefore intermediate transition areas with the smallest dimensions possible in the work piece. In addition, other objectives, aims, desirable features and characteristics will become apparent from the subsequent summary and detailed description, and the appended claims, taken in conjunction with the accompanying drawings and this background.

### SUMMARY

The device is intended for hardening a metallic work piece, particularly a tailored blank of steel or a comparable metallic material based on ferrite. The device features a conveyor for transporting the work piece along a predetermined conveying direction. In this case, the work piece preferably is moved continuously in the conveying direction. Furthermore, a heating device designed for producing a three-dimensional heating zone is provided. Referred to the conveying direction, this heating zone is shorter than the work piece. With respect to its geometric dimensions, the heating zone is realized such that the work piece transported in the feed direction by means of the conveyor only is partially heated or heated up. It is proposed to at least heat the work piece surface for the purpose of surface hardening. However, the work piece can also be heated over its entire cross section.

The heating device and therefore the hardening device is characterized in that the heating zone can be displaced in the conveying direction in order to partially heat up or heat the work piece selectively. In this way, the heating zone generated by the heating device can “travel” along with the work piece that is continuously moved in the conveying direction such that only the section situated in the heating zone, but not the sections of the work piece that lie outside the heating zone, can be heated to a predetermined temperature such as, e.g., the so-called austenizing temperature of steel.

A cooling device is arranged downstream of the heating device in order to quench the work piece heated to the predetermined temperature. A hot forming device may be optionally provided between the heating device and the cooling device in order to form the at least partially heated work piece in at least the heated regions and thusly realize its predetermined component geometry.

Since the heating device generates a heating zone that can be displaced in the conveying direction, the heating power acting upon the work piece can be reduced because the section of the work piece to be heated remains in the heating zone over a longer period of time despite the continuous feed motion.

Due to the motion of the heating zone of the heating device in the conveying direction, it is furthermore possible to achieve a more distinct transition between heated and non-heated regions of the work piece than with a stationary heating zone and a continuously conveyed work piece. In this way, a metallic work piece, particularly a tailored blank, can be hardened in a clearly defined and selective fashion.

According to a first embodiment, it is proposed that the displacement of the heating zone in the conveying direction is adapted to the transport of the work piece. It would be possible, for example, to displace the work piece and the heating zone in the conveying direction in a cyclic fashion, i.e., incrementally. However, a continuous motion of the heating zone and the work piece is preferred.

In this context, it is particularly advantageous if the transport speed of the work piece exactly corresponds to the speed of displacement of the heating zone such that only a predetermined section of the work piece can be selectively heated while other sections that lie outside this section are only barely heated or not heated that all.

According to another embodiment, it is proposed that the size of the heating zone can be varied, particularly with respect to its dimension in the conveying direction. The size of the heating zones needs to be adapted, in particular, to the dimensions of the work piece section to be hardened such that the inventive heating device can be universally utilized for a plurality of differently configured work pieces.

According to another embodiment of the invention, it is proposed that sensor-based detection elements are arranged along the conveyor in order to determine the position and/or the outer contour of the work piece. The detection elements may be realized, for example, in the form of tactile or contactless sensors such as, e.g., optical sensors.

The position, alignment and, if applicable, the geometry of the work piece can be precisely determined at any time depending on the measuring accuracy of the individual sensors and their arrangement relative to one another.

According to an additional embodiment, it is proposed, in particular, that the displacement of the heating zone or several heating zones takes place in dependence on the determined position, alignment and/or outside contour and, if applicable, with consideration of a predetermined transport speed of the conveyor. It is also proposed to respectively activate or deactivate the heating device or the heating zone or several heating zones in dependence on the determined positional and/or geometric data of the work piece.

For example, if an elongated work piece only needs to be hardened in its central region referred to the conveying direction, the heating zone is not activated until the front section of the work piece referred to the conveying direction has already passed through a not yet activated heating zone.

If a fixed transport speed is defined, it would be possible, for example, to already detect the leading front section of the work piece referred to the feed direction in a tactile or visual fashion when it enters the heating device and to subsequently activate the heating device with a corresponding time delay, namely once the central section of the work piece to be heated is positioned congruently with the heating zone generated by the heating device. The heating zone can then be moved in the conveying direction together with the work piece when or after the heating device is activated.

According to an embodiment, it is proposed that the heating device as such is realized in a stationary fashion, i.e., that the components of the heating device that serve for generating the heating zone do not have to be displaced together with the conveyor.

In this context, it is proposed, in particular, that the heating device is realized in the form of an induction heater and features induction coils that are spaced apart from one another in the conveying direction. The induction coils are arranged along the conveying direction and designed for generating at least one heating zone that extends obliquely or essentially perpendicular to the conveying direction.

As an alternative to the stationary arrangement of the heating device, it would be possible to arrange the heating device or individual components of the heating device such as, e.g., individual induction coils in such a way that they can be displaced at least in the conveying direction in order to generate a movable heating zone. In this case, it would be possible to realize, in particular, a linear motion of individual or all induction coils that enclose the work piece to be heated annularly and at least sectionally referred to the conveying direction along and/or opposite to the conveying direction.

The induction coils are preferably operated with a high-frequency alternating field in order to induce an electric current that generates heat in the work piece section to be heated. In this respect, it is proposed, in particular, that the induction coils are realized in the form of toroid coils and completely enclose the work piece in the plane extending perpendicular to the conveying direction. Consequently, the magnetic field generated by the coils for heating purposes can extend essentially parallel to the conveying direction and/or essentially parallel to the conveying direction in at least a section of the work piece.

It is furthermore proposed to provide induction coils that are spaced apart from one another in the conveying direction such that a magnetic induction field that essentially travels continuously in the conveying direction can be generated by activating adjacent induction coils accordingly. In this way, a heating zone that travels in the conveying direction can also be provided without the realization of mechanically displaceable heating elements.

The size of the heating zone, particularly its dimension in the conveying direction, can also be variably adapted by activating or deactivating individual induction coils that are arranged adjacent to one another in the conveying direction. It would furthermore be conceivable to generate not only one heating zone, but rather several heating zones that are spaced apart from one another in the conveying direction and to displace these heating zones together with the work piece.

According to another embodiment, a method is provided for partially hardening a metallic work piece that is transported along a conveying direction by means of a conveyor. In this case, at least one heating zone that can be generated by means of a heating device is displaced in the conveying direction, wherein the heating zone is shorter than the work piece referred to the conveying direction.

In this way, a metallic work piece, particularly boron-alloyed steel such as 22MnB5 or a blank manufactured thereof, can be selectively and partially heated to a temperature, at which the alpha iron (ferrite) present at room temperature transforms into gamma iron (austenite). It is proposed to quench or rapidly cool the heated section immediately after the heating process. Suitable cooling mediums for this purpose are water, oil or inert gases such as, for example, nitrogen or air.

The displacement of the heating zone or the speed of displacement is adapted to the transport or the conveying speed of the work piece.

According to another embodiment, the work piece and/or the heating zone can be continuously displaced in the conveying direction. Alternatively, it would also be possible to realize an incremental or cyclic, but preferably simultaneous displacement of the work piece and the heating zone. The speed of displacement of the work piece and the heating zone is essentially identical such that the heating zone generated by the heating device and the work piece region to be heated for the purpose of material hardening are not significantly displaced relative to one another.

It is furthermore proposed that the position and/or alignment and, if applicable, the conveying speed of the work piece can be detected by means of sensors for control purposes, e.g., in order to activate and deactivate the heating device and/or to displace the heating zone. It is furthermore proposed that the work piece is selectively quenched or rapidly cooled after it was at least partially heated to the predetermined temperature, at which the work piece regions to be hardened transform to the so-called austenitic phase, in order to achieve a predetermined degree of hardness or the selective and controlled formation of martensite.

It is furthermore proposed that the work piece is subjected to a forming process after it was at least regionally heated, preferably during the subsequent quenching. In this respect, it would be possible to realize, for example, an active cooling of the forming tool.

The described device and the method for hardening a metallic work piece can be universally utilized in connection with tailored blanks, as well as coiled strip materials such as steel strips. It would furthermore be possible to utilize starting materials in the form of so-called Tailor Rolled Blanks or Tailor Rolled Coils that may have different sheet thicknesses in the rolling direction due to a controlled modification of the roll gap during the cold rolling process. In this respect, the work pieces to be hardened may have a plane, essentially flat outer contour or even an undulated shape or a discontinuous cross-sectional profile. The described method can also be universally utilized in connection with components that already were arbitrarily form or deformed.

According to another embodiment, a metallic work piece is provided, particularly a car body part for a motor vehicle, with at least two surface sections that lie adjacent to one another in a conveying direction and have different degrees of hardness, wherein said metallic work piece can be manufactured or partially hardened, in particular, in accordance with the above-described method and/or by means of the device.

In this case, the work piece is characterized in a particularly small size of the transition area between the surface sections with different degrees of hardness. The dimension or the size of the transition area between surface sections with different degrees of hardness amounts to less than approximately 20 mm, preferably less than approximately 10 mm, particularly less than approximately 5 millimeter. The term transition area refers to the area between two surface sections with essentially constant work piece hardness. In this context, it is characterized by a three-dimensionally modulated work piece hardness referred to the conveying direction. Due to the inventive reduction of the transition area between surface sections of a car body part that have different degrees of hardness, deviations between simulated and experimental car crashes can be minimized.

According to an additional embodiment, the work piece has a structurally strengthening or reinforcing car body part. It is proposed, in particular, that the work piece has an A- or B-column, a corresponding column reinforcement, a roof reinforcement, a window frame reinforcement, a door impact beam reinforcement, a rocker panel reinforcement or a lateral beam reinforcement. It would also be conceivable to realize the partially hardened metallic work piece in the form of an underbody, base plate, tunnel, instrument panel support or bumper for a motor vehicle.

### BRIEF DESCRIPTION OF THE DRAWINGS

The present invention will hereinafter be described in conjunction with the following drawing

FIG. 1 that shows a schematic representation of an inventive heating device.

### DETAILED DESCRIPTION

The following detailed description is merely exemplary in nature and is not intended to limit application and uses. Furthermore, there is no intention to be bound by any theory presented in the preceding background or summary or the following detailed description.

The heating device 10 is realized in the form of a so-called hardening furnace and can be operated as a continuous furnace, wherein said heating device features a conveyor 11, on which the work piece 20 to be partially hardened can be continuously or incrementally transported in a conveying direction 28, namely from the left toward the right referred to the geometry of the figure.

Induction coils 12, 14, 16 are arranged around the conveyor and spaced apart from one another in the conveying direction, wherein these induction coils generate an induction field 30 for partially heating the work piece 20 when they are acted upon with a corresponding high-frequency signal. The induction field 30 simultaneously represents a heating zone, the geometric dimension of which in the conveying direction 28 is smaller than the size of the work piece 20 in the conveying direction 28.

A heating zone 30 that travels with the work piece 20 can be generated by activating and deactivating induction coils 12, 14, 16 such that the work piece 20 can only be subjected to an energy input in a predetermined region of limited size during its continuous transport through the hardening furnace 10 and the work piece 20 therefore only is locally heated in a predetermined region 24. Since the heating zone 30 travels with the work piece 20, this region 24 of the work piece 20 can be continuously heated over the entire length of the conveyor 11.

This means that particularly high temperature gradients are created in the transition areas to the left and the right of the heated work piece section 24. In this way, three-dimensional temperature differences can be realized in the material with exceptional precision. The subsequent quenching process and, if applicable, an intermediate forming process make it possible to produce regions in the work piece 20 that are separated from one another in a relatively clear and distinct fashion, wherein these regions have different degrees of hardness and therefore a different structural rigidity. The size of the transition area between hardened and non-hardened sections therefore can be reduced to a minimum.

Furthermore, position sensors 18 are arranged along the transport section defined by the conveyor 11 and designed for detecting the position, the alignment and, if applicable, the outer contour and the geometry of the work piece. These sensors may be realized, for example, in the form of light barriers or tactile sensor elements, i.e., touch sensor elements. Instead of using a plurality of individual sensors 18, it would also be conceivable to provide one or a few imaging sensors in connection with a corresponding image analysis.

The signals generated by the sensors 18 are fed to an image analysis and process control that controls the activation of the heating device and a corresponding displacement of the heating zone 30 together with the work piece in dependence on the sensor signals. It would also be possible to vary the size of the heating zone, e.g., by activating or deactivating individual induction coils 12, 14, 16. In this way, the dimensions of the work piece section 24 to be heated can be universally varied. It would also be conceivable to activate not only one heating zone 30, but several heating zones that are spaced apart from one another in the conveying direction 21 simultaneously or with a time delay that corresponds to the speed of displacement of the work piece 20 and to displace these heating zones parallel to the work piece such that several regions of the work piece 20 can be simultaneously heated with the described process and hardened by means of rapid subsequent cooling.

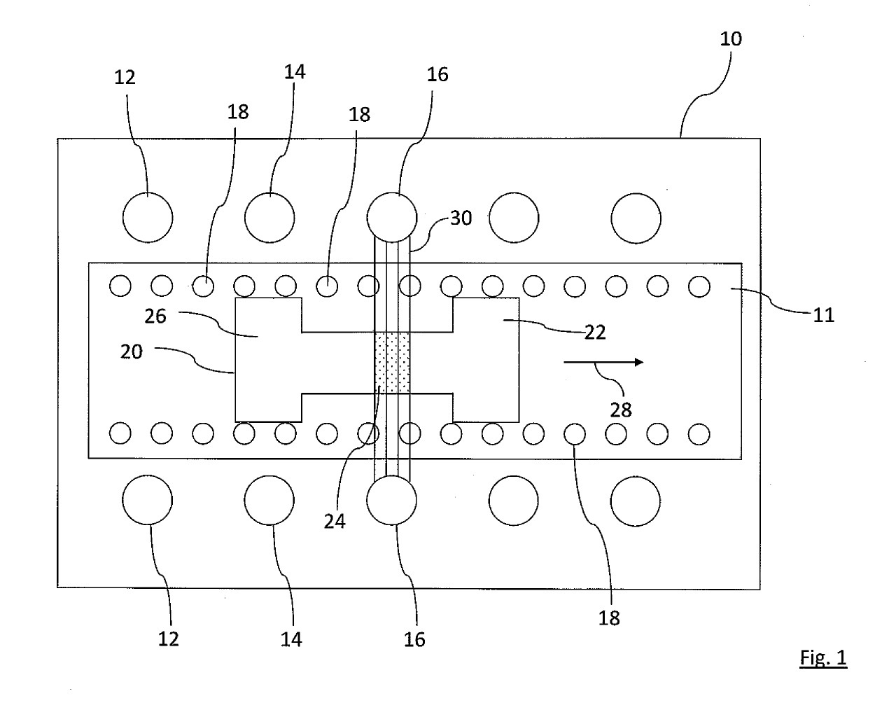

In the exemplary embodiment illustrated in FIG. 1 that features only one heating zone 30, only the central work piece section 24 is subjected to a partial hardening process while the front section 22 referred to the conveying direction and the rear section 26 referred to the conveying direction should not be subjected to any further heat treatment.

For example, if boron-alloyed steel such as the material 22MnB5 is used, the temperature to be reached in the work piece section 24 approximately lies between approximately 900° C. and approximately 950° C. The regions of different hardness that can be produced in the work piece by means of the invention result in a component that also features sections with different forming and bending properties regardless of its geometric shape.

This is particularly important in the automobile industry in order to ensure that the car body and its individual components have a required deformation behavior during a side impact or head-on collision. In this respect, such partially hardened work pieces are suitable for use as a cost-efficient and easily manageable replacement for Tailored Welded Blanks or Tailored Welded Coils.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A device for partially hardening a metallic work piece, comprising:
a conveyor configured to transport the metallic work piece along a conveying direction; and
a heating device configured to generate a heating zone that is shorter than the metallic work piece in the conveying direction,
the heating device is further configured to displace the heating zone in the conveying direction in order to partially heat the metallic work piece.

2. The device according to claim 1, wherein displacement of the heating zone adapted to the transport of the metallic work piece.

3. The device according to claims 1, wherein a size of the heating zone is variable in a dimension along the conveying direction.

4. The device according to claim 1, further comprising a sensor-based detector arranged along the conveyor in order to determine a position of the metallic work piece.

5. The device according to claim 1, wherein displacement of the heating zone takes place in dependence on a determined position and, if applicable, with consideration of a predetermined conveying speed of the conveyor.

6. The device according to claim 1, wherein the heating device is stationary.

7. The device according to claims 1, wherein the heating device is an induction heater and comprises induction coils that are spaced apart from one another in the conveying direction.

8. The device according to claim 1, further comprising a plurality of induction coils that are spaced apart from one another in the conveying direction that are arranged along the conveyor in order to generate the heating zone that extends with respect to the conveying direction.

9. A method for partially hardening a metallic work piece, comprising:
transporting the metallic work piece along a conveying direction with a conveyor;
generating a heating zone with a heating device that is shorter than the metallic work piece in the conveying direction,
wherein the heating zone is displaced in the conveying direction in order to partially heat the metallic work piece.

10. The method according to claim 9, wherein the transporting of the metallic work piece comprises displacing of the heating zone.

11. The method according to claim 9, wherein the displacing is conducted substantially continuously displaced in the conveying direction.

12. The method according to claim 9, wherein displacing is conducted substantially continuously displaced with an essentially identical speed.

13. The method according to claim 9, further comprising:
detecting with a first sensor a position of the work piece; and
detecting a speed with a second sensor;
controlling the heating device based at least in part on the position and the speed.

14. The method according to claim 9, further comprising cooling the metallic work piece.

15. The method according to claim 14, further comprising subjecting the metallic work piece to an at least partial forming process after the cooling.

16. A metallic work piece, comprising:
first surface sections having a first degree of hardness;
a second surface section having a second degree of hardness that is different than the first degree of hardness and lies adjacent to the first surface section in a conveying direction; and
a size of a transition area between the first surface section and the second surface sections having different degrees of hardness amounts to less than approximately 20 mm, in the conveying direction.

17. The work piece according to claim 16, wherein in the metallic work piece is a body part of a motor vehicle.

18. The work piece according to claim 16, wherein the different degrees of hardness amounts are less than approximately 10 mm in the conveying direction.

19. The work piece according to claim 16, wherein the different degrees of hardness amounts are less than approximately 5 millimeter in the conveying direction.
